(19) United States
(12) Patent Application Publication
(10) Pub. No.: US 2011/0169428 A1
(43) Pub. Date: Jul. 14, 2011

(54) EDGE BAR DESIGNS TO MITIGATE EDGE SHADOW ARTIFACT

(75) Inventors: Lai Wang, Milpitas, CA (US); Ion Bita, San Jose, CA (US); Marek Mienko, San Jose, CA (US); Kollengode S. Narayanan, Cupertino, CA (US); Russell Wayne Gruhlke, Milpitas, CA (US)

(73) Assignee: QUALCOMM MEMS TECHNOLOGIES, INC., San Jose, CA (US)

(21) Appl. No.: 12/684,656

(22) Filed: Jan. 8, 2010

(51) Int. Cl. H05B 39/00; F21V 7/04; H01R 43/00

(52) U.S. Cl. 315/312; 362/613; 362/609; 362/615; 29/825

(57) ABSTRACT

An edge bar having features that discriminate between light propagating in one direction versus the opposite direction may be configured so as to couple light into a light guide while significantly mitigating against edge shadow artifact.

### BACKGROUND

1. Field of the Invention

The invention relates generally to display devices for actively displaying images. More specifically, some embodiments relate to an illumination device for display devices. In some embodiments, the illumination device mitigates or overcomes an “edge shadow” or a “screen door” effect or artifact.

2. Description of Related Technology

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

In one embodiment, an illumination device comprises an edge bar configured to have light propagating in a first direction along a length of the edge bar and light propagating in an opposite direction along the length of the edge bar. The edge bar comprises a first and a second opposing ends, a light-exit side, an opposing side opposite the light-exit side, and a top side and a bottom side adjacent the light-exit surface. The edge bar also comprises a first light source optically coupled to the first opposing end such that light from the first light source enters the edge bar and propagates in the first direction and a first light-turning feature formed on one of the opposing side, the light-exit side, the top side, and the bottom side, wherein the first light-turning feature extracts more light that propagates in the first direction than the feature extracts from light that propagates in the opposite direction. In some embodiments, the edge bar is coupled to a light guide and the edge bar and the light guide are configured to reduce an edge shadow in the light guide compared to an edge bar having light-extracting turning features that extract light substantially equally in the first and opposite directions. In some embodiments, the edge bar further comprises a second light source optically coupled to the second opposing end such that light from the second light source enters the edge bar and propagates in the opposite direction. In some embodiments, the edge bar further comprises a second light-turning feature, wherein the second light-turning feature extracts more light propagating in the opposite direction than in the first direction. In some embodiments, the first and second light-turning features comprise asymmetric facets.

In one embodiment, an illumination device comprises a light-guide means for guiding light in a first direction along a length of the light-guide means and for guiding light in an opposite direction along the length of the light-guide means. The light-guide means comprises a first and a second opposing ends, a light-exit side, an opposing side opposite the light-exit side, and a top side and a bottom side adjacent the light-exit surface. The illumination device also comprises a first illuminating means for providing to the first opposing end such that light from the first illuminating means enters the light-guide means and propagates in the first direction. The illumination device also comprises a first light-turning means for turning light out of the light-guide means formed on one of the opposing side, the light-exit side, the top side, and the bottom side, wherein the first light-turning means extracts more light that propagates in the first direction than the feature extracts from light that propagates in the opposite direction. The illumination device also comprises a second light-turning means for turning light out of the light-guide means formed on one of the opposing side, the light-exit side, the top side, and the bottom side, wherein the second light-turning means extracts more light that propagates in the opposite direction than in the first direction.

In one embodiment, a method of manufacturing an illumination device comprises providing an edge bar configured to have light propagating in a first direction along a length of the edge bar and light propagating in an opposite direction along the length of the edge bar and forming a first light-turning feature formed on one of the opposing side, the light-exit side, the top side, and the bottom side, wherein the first light-turning feature extracts more light that propagates in the first direction than the feature extracts from light that propagates in the opposite direction.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 is an illustration of an embodiment of a light guide exhibiting edge shadow artifact.

FIG. 9A is an illustration of an embodiment of an edge bar having turning features with symmetric facets.

FIG. 9B is an illustration of another embodiment of an edge bar having turning features with symmetric facets.

FIG. 9C is an illustration of an embodiment of an edge bar having turning features with symmetric facets with two LEDs on opposite ends.

FIGS. 10A-10B are illustrations of embodiments of edge bars with turning features with asymmetric facets oriented to extract more light propagating in one direction than light propagating in the opposite direction.

FIGS. 11A-11D are illustrations of embodiments of edge bars with two sets of light-turning features.

FIG. 12A is an illustration of an embodiment of an edge bar having light-turning features with asymmetric facets.

FIG. 12B is an illustration of another embodiment of an edge bar having light-turning features with asymmetric facets

FIG. 12C is an illustration of an embodiment of an edge bar having light-turning features with asymmetric facets with two LEDs on opposite ends.

FIG. 13 illustrates a graph of light-turning feature cut depth as a function of position along the length of the edge bar.

FIG. 14A is an illustration of an embodiment of an edge bar having light-turning features of varying cut depth with asymmetric facets.

FIG. 14B is an illustration of another embodiment of an edge bar having light-turning features of varying cut depth with asymmetric facets

FIG. 14C is an illustration of an embodiment of an edge bar having light-turning features of varying cut depth with asymmetric facets with two LEDs on opposite ends.

FIG. 15A-15C illustrates graphs of light-turning feature cut depth as a function of position along the length of the edge bar.

FIGS. 16A and 16B illustrate embodiments similar to FIGS. 11A-11C, 12C, and 14C with only one LED.

### DETAILED DESCRIPTION OF CERTAIN EMBODIMENTS

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

The various embodiments disclosed herein relate to an illumination device for display devices. In some embodiments, the illumination device mitigates or overcomes an “edge shadow” or a “screen door” effect or artifact. In some embodiments, the device comprises an edge bar or light bar with light-turning features that turn or eject more light propagating in one direction than in the opposite direction. Using such features, the edge bar may improve the edge shadow effect.

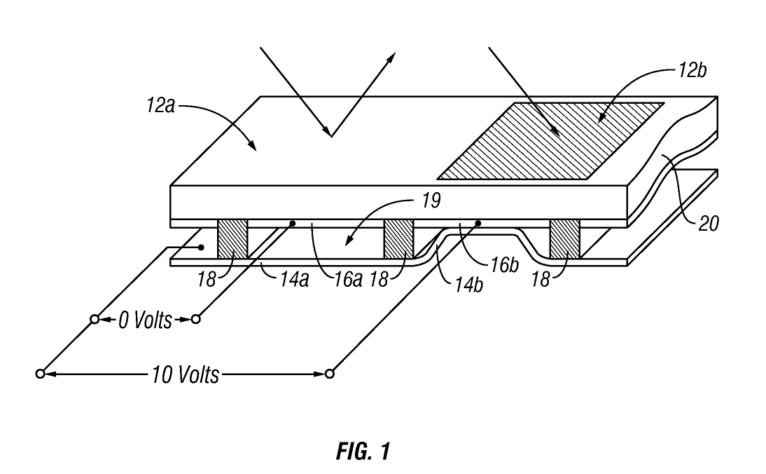

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this figure) within the optical stack 16 may prevent shorting and control the separation distance between layers 14 and 16, as illustrated by actuated pixel 12b on the right in FIG. 1. The behavior is the same regardless of the polarity of the applied potential difference.

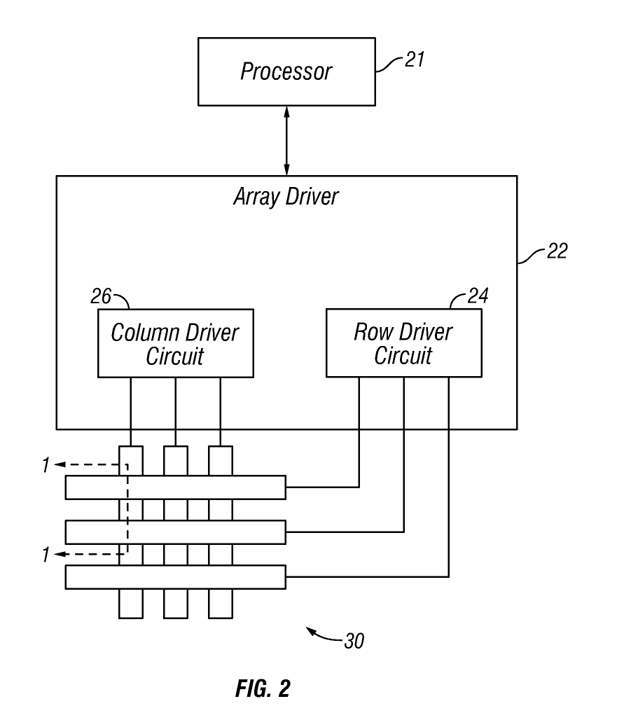

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

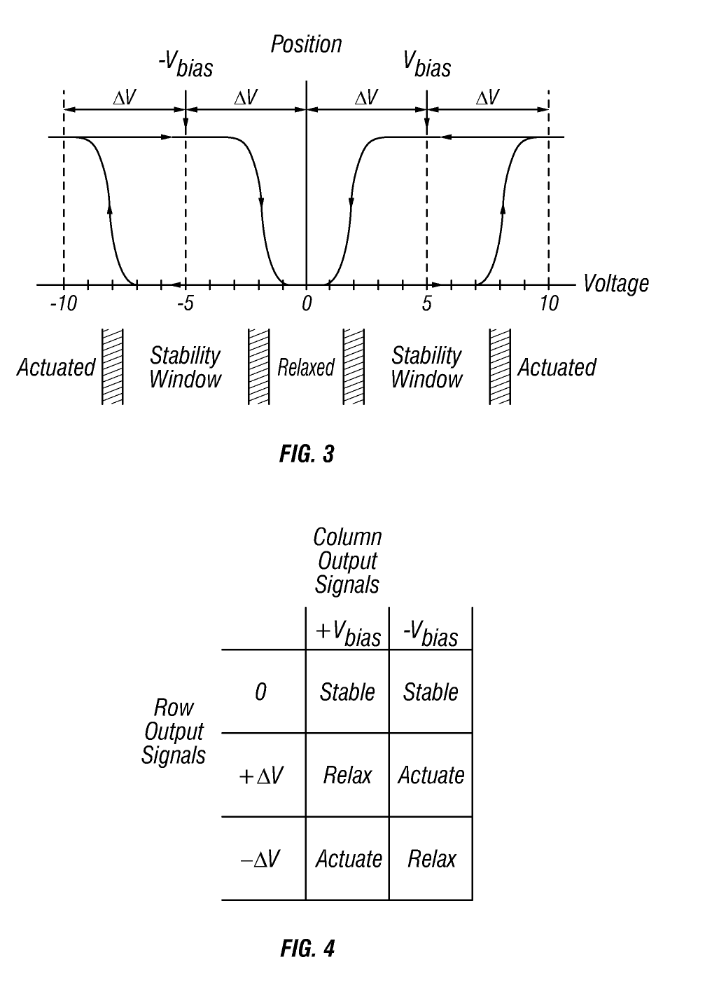

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

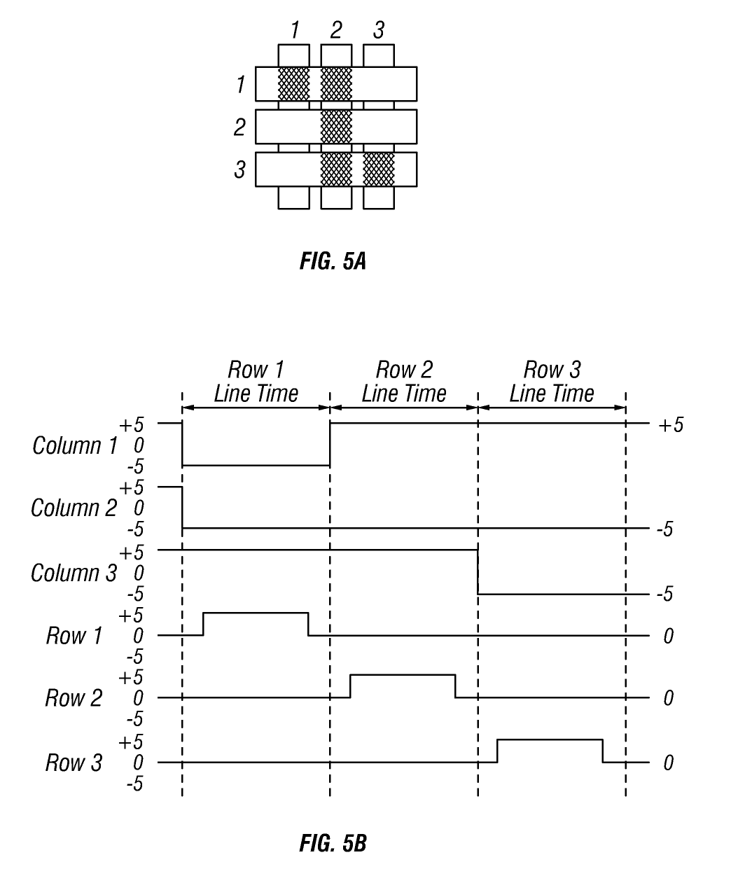

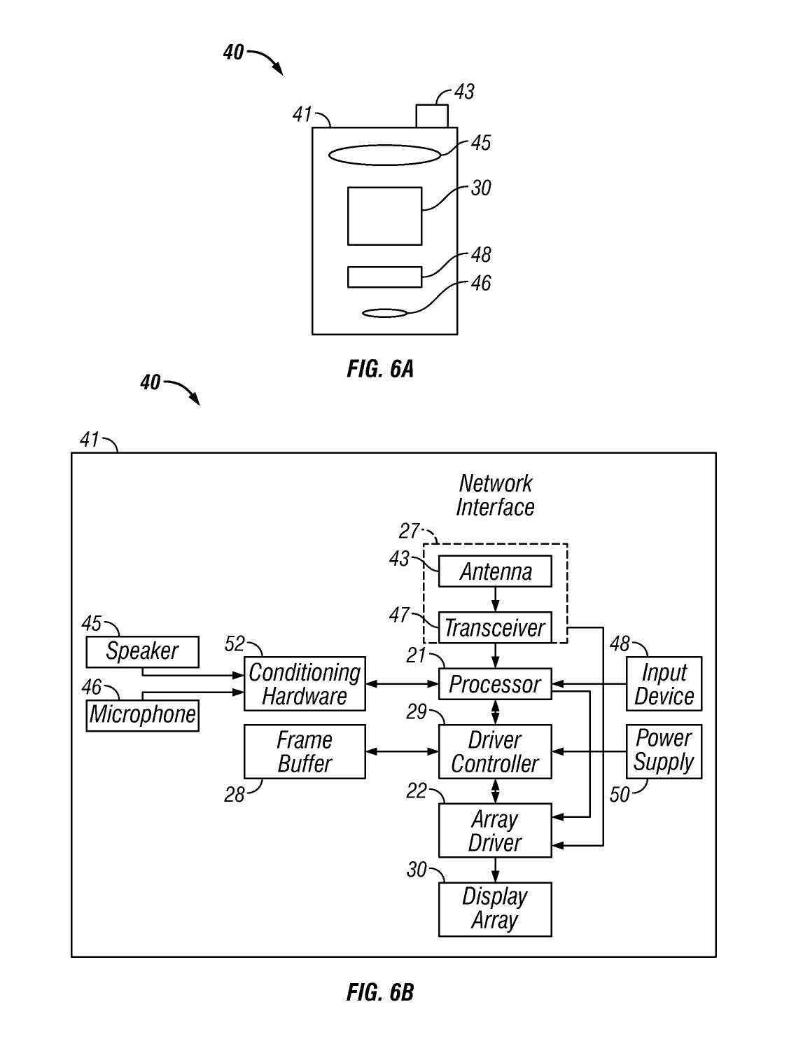

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively. Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

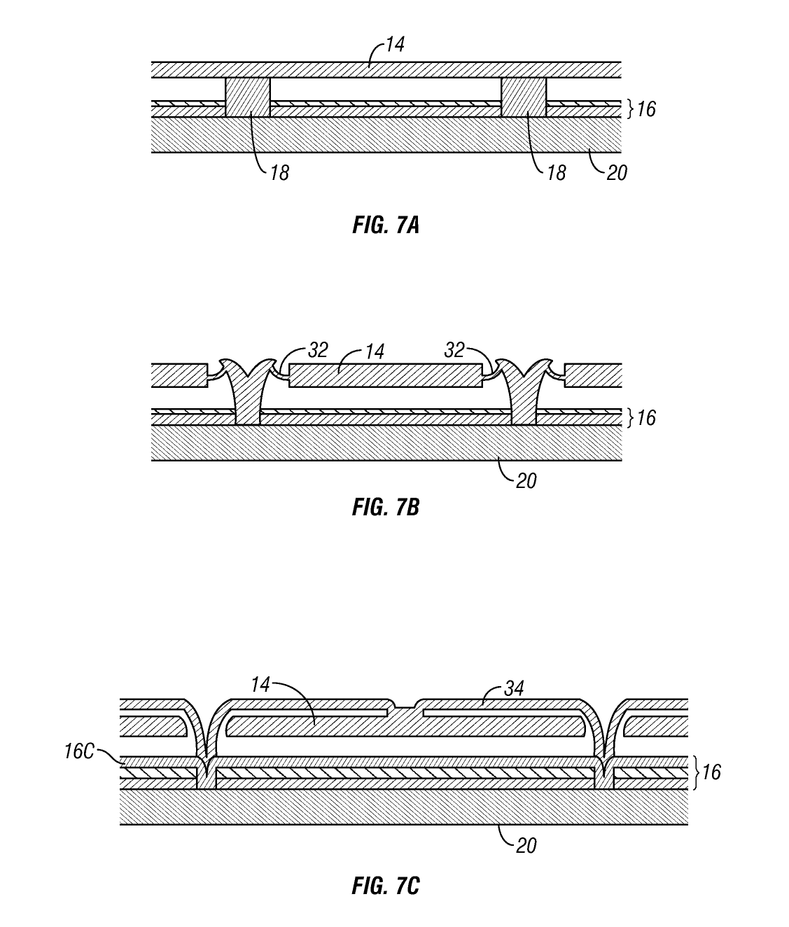

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

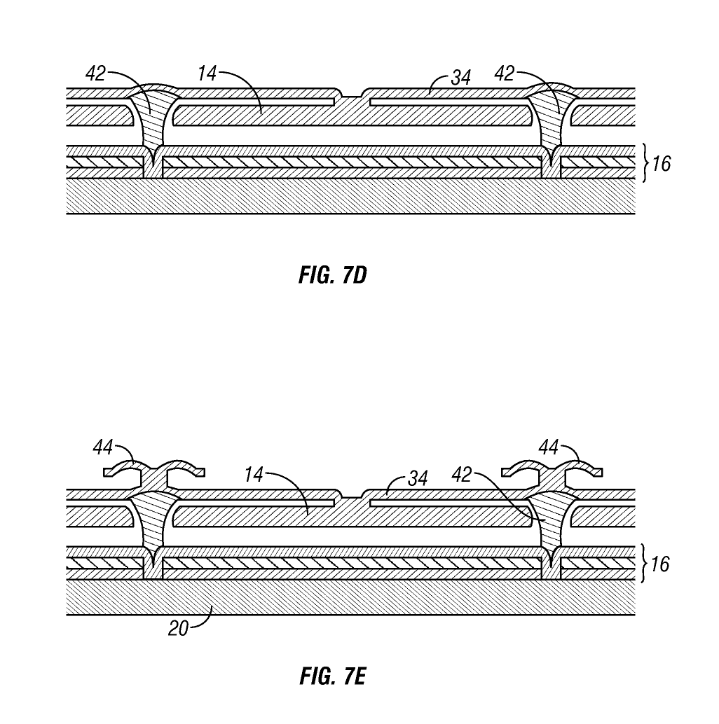

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

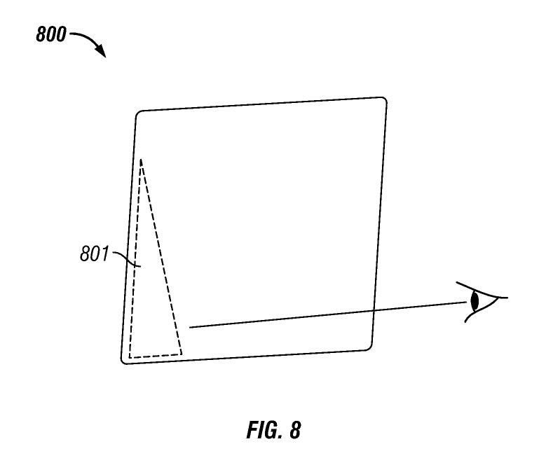

Reflective displays, such as reflective displays comprising interferometric modulators such as the embodiments shown in FIGS. 7C-7E, may advantageously reflect ambient light towards a viewer thereby providing the viewer with a displayed image. However, in some circumstances, reflective displays, for example displays comprising arrays of interferometric modulators such as those of the embodiments illustrated in FIGS. 7A-7E or other reflective displays, may require additional illumination to be easily seen by a viewer. Such additional illumination may be provided for by an illumination device or system. In some embodiments, an illumination system comprises one or more light sources (such as an LED, etc.), an edge bar (often also called a light bar) for spreading light, and a light guide. Light from the source(s) can enter the edge bar and spread along a length of the edge bar. Such light may then be directed toward a side or a surface of the light guide and be coupled along the side or surface of the light guide to be further spread along the length of the lightguide across a wide area and then be directed onto an array of display elements. The light can be directed toward the light guide by a plurality of light-turning features in the edge bar. However, many single or dual LED edge bars coupled to light guides produce an edge shadow artifact 801 in the illumination field of the light guide 800, as shown in FIG. 8. When the light guide 800 is viewed from an off-normal direction, a dark triangle-shaped area 801 appears at the edge away from the viewer. The appearance of this area 801 is called the edge shadow artifact or screen door effect.

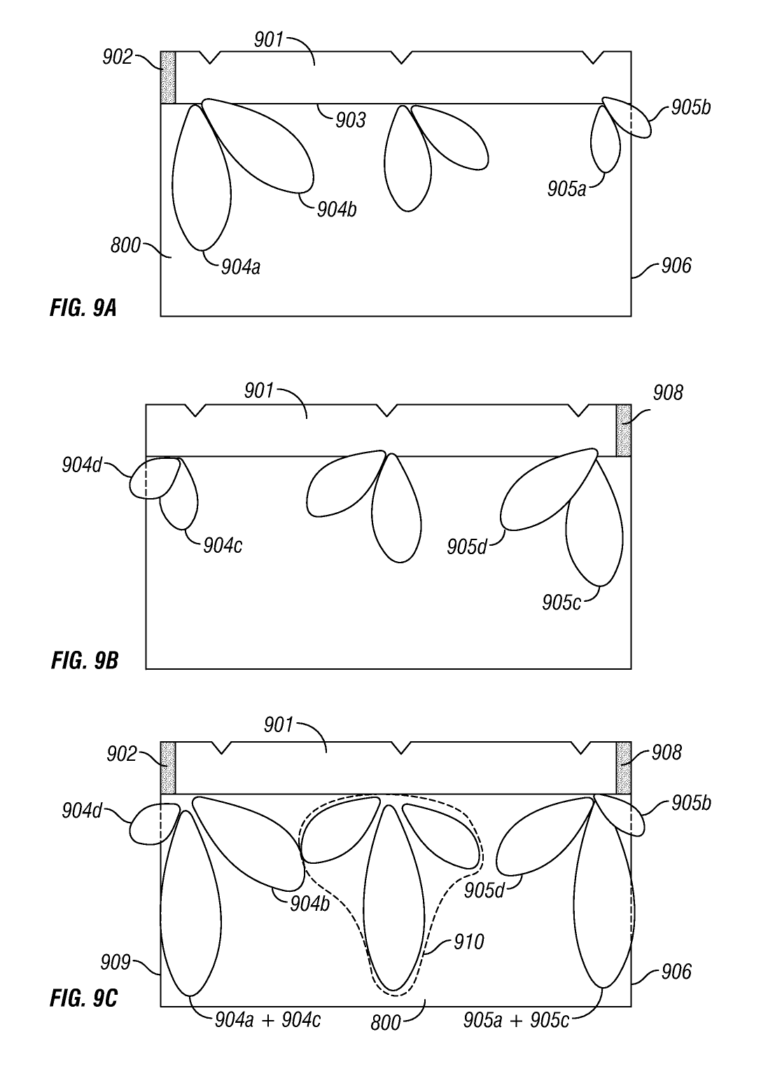

FIG. 9A illustrates an embodiment of an edge bar 901 having turning features with symmetric light-extracting facets. As illustrated, the edge bar 901 comprises a first and second opposing ends, with an LED 902 placed at the first opposing end of the edge bar 901. As shown in FIG. 9A, the edge bar 901 directs light injected into the edge bar 901 by LED 902 out of the edge bar 901 through light-exit side 903. In some embodiments, the light is directed out of the edge bar 901 in different lobes. For example, the light may be directed out of the edge bar 901 in main lobes 904a, 905a and side lobes 904b, 905b. Side lobe 905b is considered to be a “good side lobe,” because side lobe 905b may be largely reflected or scattered by the edge 906 of a light guide 800. However, side lobe 904b is considered to be a “bad side lobe,” because side lobe 904b is generally not reflected or scattered, and therefore contributes to the edge shadow artifact. An LED 908 may be placed on the second, opposing end of the edge bar 901, as shown in the embodiment of FIG. 9B.

FIG. 9B illustrates an embodiment of an edge bar 901 similar to that of FIG. 9A, but with LED 908 placed or disposed on the second, opposing end of the edge bar 901 opposite the side on which LED 902 is placed or disposed in FIG. 9A. As illustrated in the embodiment of FIG. 9B, main lobes 904c, 905c and side lobes 904d, 905d are possible.

As shown in FIG. 9C, in some embodiments, it is possible to have an edge bar 901 with an LED 902, 908 on both the first and second opposing ends of the edge bar 901. In such a case, the main and side lobes may be superimposed (i.e., the side lobes of FIG. 9A may be superimposed over the side lobes of FIG. 9B). As illustrated, this may result in three lobes, with a main lobe (904a+904c, 905a+905c) and two sides lobes (904b and 904d, 905b and 905d). Like side lobe 905b, side lobe 904d may be reflected or scattered by edge 909 of the light guide.

Side lobes 904d (scattering off of edge 909) and 905b (scattering off of the edge 906) may help to mitigate edge shadow artifact. However, as can be seen from FIG. 9C, while side lobe 904d is a “good side lobe,” it is much smaller than side lobe 904b. Similarly, while 905b is a “good side lobe,” it is much smaller than side lobe 905d. These “good” side lobes reduce the edge shadow artifact, but some artifact still remains in view of the relatively larger “bad” side lobes 904b and 905d.

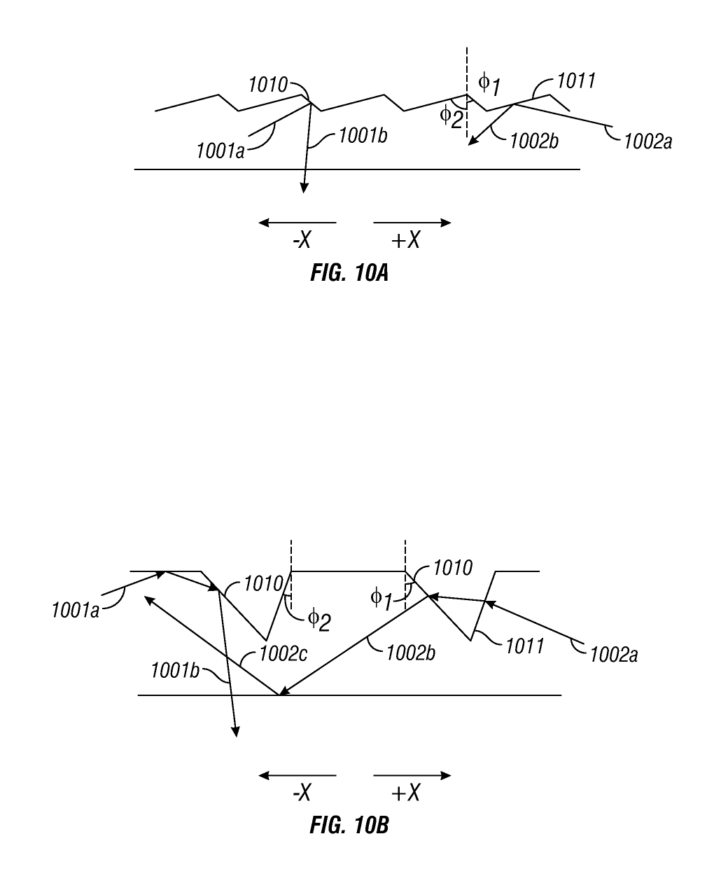

One way to overcome this difficulty is to use light-turning features which extract or eject light out of the light bar, but have greater extraction for light travelling in one direction than for light travelling in an opposite direction. For example, the light-turning features comprising asymmetric facets shown in FIG. 10A may extract more light propagating in one direction than light propagating in the opposite direction. For example, the facets on the light-turning features may be oriented to generally extract light propagating in the +x direction, but not generally extract light travelling in the −x direction. This is achieved by choosing angles φ₁ and φ₂. For example, if φ₁ is relatively small, e.g., 48°, rays like 1001a may hit facet 1010 and be ejected due to total internal reflection, as illustrated by ray 1001b. If φ₂ is large, e.g., 86°, rays propagating in the −x direction may hit facet 1011, as shown in ray 1002b, and continue propagation along the light guide due to total-internal-reflection.

Another example of turning features comprising asymmetric facets which extract or eject light out of the edge bar depending upon the direction of propagation is the half-V groove of FIG. 10B. As can be seen in FIG. 10B, the light-turning feature is capable of extracting the light that is propagating in the +x direction, as illustrated by ray 1001a. As illustrated, ray 1001a hits facet 1010 and is ejected as shown by ray 1001b. However, rays like 1002a that are traveling in the opposite direction, e.g., the −x direction, may hit facet 1011 at a near-normal angle. This may cause ray 1002a to exit the light bar briefly until it encounters facet 1010, thereby re-entering the light bar. Upon re-entry, this light will continue to propagate along the light bar as shown by rays 1002b and 1002c. Other turning features, such as diffraction features or holograms are also possible.

In one embodiment, the faceted features can be fabricated by imprinting the surface relief geometry on a substrate. For example, a roll-to-roll embossing (e.g., hot or UV) or casting process may be used to imprint the faceted features on the substrate. For embodiments with facets formed on a surface of the edge bar opposite the light exit side 903, the substrate may be fairly thick, e.g., 1-10 mm. Once the faceted features are imprinted on, e.g., an upper surface of the thick substrate, the substrate may be sliced to whatever thickness desired for the edge bar. In some embodiments, the edge bar may be a few mm high. In some embodiments, the edge bar may be about 1 mm high. In some embodiments, the edge bar may be less than 1 mm. In some embodiments, the edge bar may be much less, e.g., 25-350 μm. In an exemplary embodiment, the edge bars are cut to have dimensions of about 40 mm×3 mm, with varying thicknesses as described above. Other methods, such as injection molding, may also be used. Other approaches are possible.

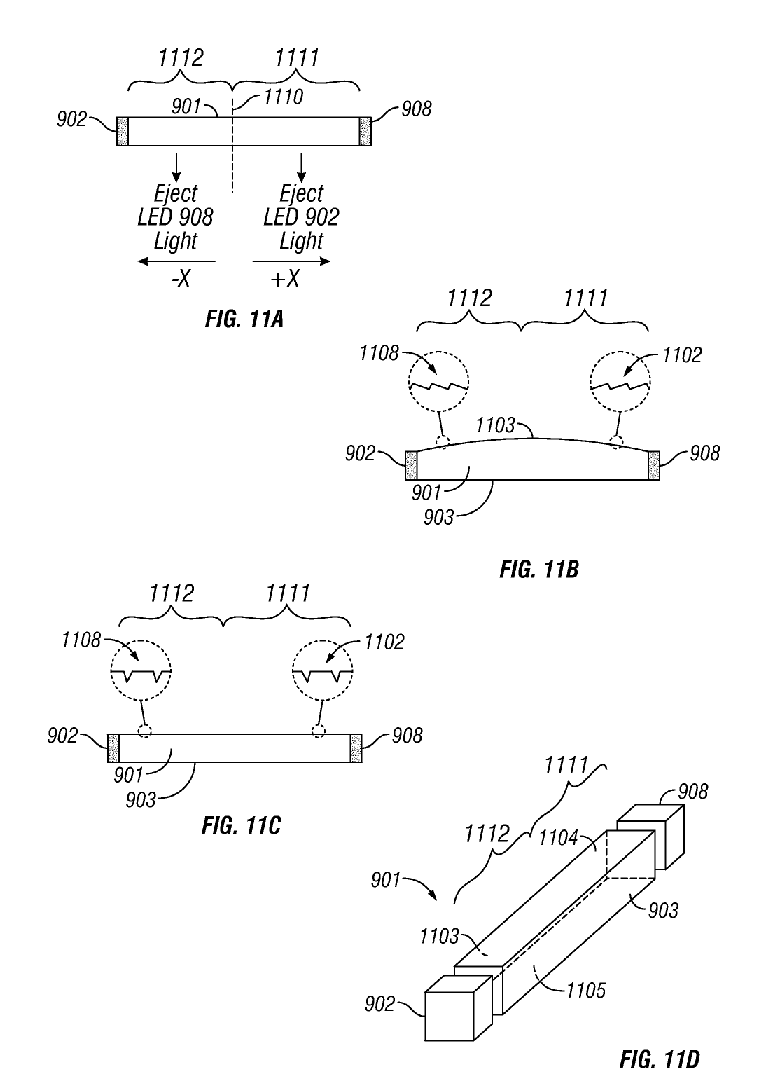

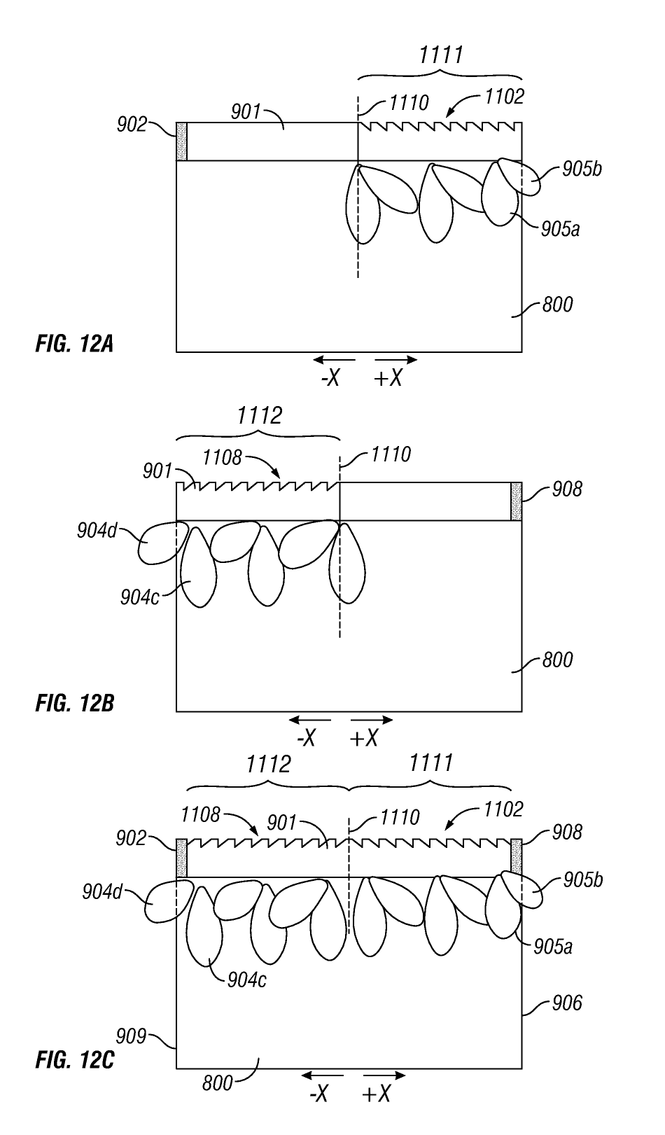

An edge bar with turning features having properties similar to the facets of FIGS. 10A and 10B may be useful in mitigating edge shadow. This can be accomplished by an edge bar 901 with two different sets of features, a first set of features and a second set of features, each set of features configured to extract light propagating in opposite or opposing directions. FIG. 11A illustrates an embodiment of an edge bar 901 having a first set 1111 of light-turning features configured to eject light propagating in one direction, e.g., propagating away from LED 902 or in a +x direction, and a second set of 1112 of light-turning features configured to eject light propagating in the opposite direction or in a −x direction, e.g., propagating away from LED 908. As a result, most of the light ejected by the first set 1111 is injected by LED 902, while most of the light ejected by the second set 1112 of features is injected by LED 908. This can be accomplished, as illustrated in FIGS. 11B and 11C, by using a first set 1111 and a different, second set 1112 of turning features having asymmetric facets of different orientations. While light injected by LED 902 is ejected or extracted generally by the first set 1111 of features and light injected by LED 908 is ejected generally by the second set 1112 of features, it is understood from the above that it is the direction of propagation of the light that primary affects which set of features ejects the light. Also, while the first set 1111 and the second set 1112 are shown in separate regions in the embodiments illustrated in FIGS. 11A-11D and 12C, in other embodiments, the first set 1111 and the second set 1112 are disposed throughout most or all of the edge bar 901. In some embodiments, there is a greater number of turning features of the first set 1111 further away from LED 902 than there are closer to LED 902, and there is a greater number of turning features of the second set 1112 further away from LED 908 than there are closer to LED 908.

FIGS. 11B and 11C illustrate embodiments of an edge bar 901 having a first set 1111 of light-turning features 1102 and a second set 1112 of light-turning features 1108. The first set 1111 comprises light-turning features 1102 that primarily eject or extract light propagating in one direction, e.g., away from LED 902 in the +x direction. Hence the first set 1111 of light-turning features 1102 primarily eject light from LED 902. Similarly, the second set 1112 comprises light-turning features 1108 that primarily eject or extract light propagating in the opposite direction, e.g., away from LED 908 in the −x direction. Hence, the second set 1112 comprises light-turning features 1108 that primarily eject light from LED 908. It is noted that the embodiments illustrated in FIGS. 11B and 11C have an opposite side 1103 to the light-exit side 903 comprising straight surfaces or curved surfaces. Similarly, while the light-turning features are shown on the opposite side 1103, the light turning features or light managing features (i.e. microlens, or other examples) may be on the light-exit side 903. Those features may also be formed on top 1104 and bottom 1105 sides, which are both adjacent to the light-exit-side 903, of the edge bar 901. In the embodiments illustrated in FIGS. 11B and 11C, some of the facets of the first set 1111 of the light-turning features 1102 are mirror symmetric to some of the facets of the second set 1112 of the light-turning features 1108. In such an embodiment, there may be a line or plane of symmetry (about which some or all of the facets of the two sets 1111, 1112 of light-turning features 1102, 1108 are mirror symmetric) that is perpendicular to the x-axis joining the two light sources (e.g., LEDs).

FIG. 11D illustrates an embodiment of an edge bar 901. In the three-dimensional perspective illustration of FIG. 11D, the light-exit side 903, the opposing side 1103, the top side 1104 and the bottom side 1105 are all shown.

FIG. 12A illustrates an embodiment of the main and side lobes resulting from facets in light-turning features configured and/or oriented as shown in FIGS. 11A-11C. Because the light from LED 902 is ejected mostly by set 1111 further away from LED 902, as illustrated in FIG. 12A, the problematic “bad” side lobe 904b is substantially reduced. Similarly, because the light from LED 908 is ejected mostly by set 1112, as illustrated in FIG. 12B, problematic “bad” side lobe 905d is substantially reduced. Hence, when both LEDs 902, 908 are used together, and where the first set 1111 of light-turning features 1102 in the edge bar is configured to eject mostly light travelling in the +x direction and the second set 1112 of light-turning features 1108 in the edge bar is configured to eject mostly light travelling in the −x direction, as shown by the superimposition of FIGS. 12A and 12B in FIG. 12C, only “good” side lobes 904d and 905b are present. In some embodiments, side lobes 904b and 905d (shown in FIG. 9C) may be significantly reduced or eliminated, thereby reducing the edge shadow artifact.

However, while the embodiment of FIG. 12C may reduce the edge shadow artifact, it may, in some embodiments, have a somewhat darkened line along the center 1110 of edge bar 901 when coupled into light guide 800. To reduce this darkened line, some embodiments include an “enforced center section.” In one embodiment, for example, the center of the edge bar 901 may be “enforced” by placing several light-turning features comprising symmetric facets at or near the center. In other words, near the center, several light-turning features are placed that eject light traveling in both the +x and the −x directions with similar or equal efficiency. Advantageously, in this embodiment, the central lobe may two side lobes (similar to central lobe 910 of FIG. 9C), while the lobes closest to the center 1110 of the edge bar in FIG. 12C may have only one side lobe. However, since the light-turning features with symmetric facets are only near the center, and not near the edges 906 or 909, the “bad” side lobes 904b and 905d of FIG. 9C may still be reduced, avoided or minimized. Hence embodiments with the symmetric light-turning features at or near the center, but generally not near the LEDs 902, 908, may reduce the darkened line along the center 1110 of the edge bar 901, while still mitigating the edge shadow artifact.

In the embodiment illustrated in FIGS. 11B-11C and 12A-12C, the light-turning features are all illustrated as cut to an equal depth into the edge bar 901. However, in some embodiments, the cut depth of the light-turning features can be varied. For example, in some embodiments, the cut depth can be varied along the length of the edge bar 901. Therefore, any of the embodiments illustrated in FIGS. 11B-11C and 12A-12C may include light-turning features of variable cut depth.

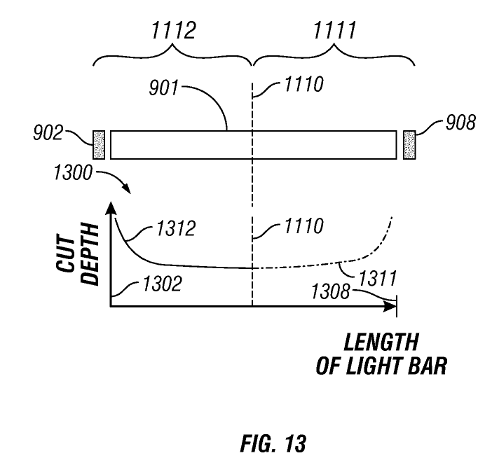

FIG. 13 shows a graph depicting cut depth as a function of position along the length of the light bar. Hence, point 1302 in graph 1300 corresponds to the location of the LED 902 and point 1308 correspond to the location of the LED 908. As shown in graph 1300, the cut depth is largest near the LEDs 902, 908 and the cut depth is reduced, e.g., at a minimum near the center 1110 of the edge bar 901. It is noted, however, that the first set 1111 of features 1102 extract light primarily from, more from or only from LED 902, as described above. Line 1311 represents the cut depth of these features 1102. Similarly the second set 1112 of features 1108 extract light primarily from, more from or only from LED 908, as described above. Line 1312 represents the cut depth of these features 1108. Therefore, while the cut depth is illustrated as maximum closest to the LEDs and reduced, e.g., as minimum near the center 1110, it is noted that the features that extract light from LED 902 are larger further away from LED 902, and the features that extract light from LED 908 are larger further away from LED 908. Hence the features that extract light from LED 902 are largest near LED 908, and the features that extract light from LED 908 are largest near LED 902. Hence, in some embodiments, the cut depth of the first set 1111 of features 1102 and the second set 1112 of features 1108 varies, e.g., increases as a function of distance from the source of light.

As noted above, the use of light-turning features with asymmetric facets in different regions of the edge bar may cause a dark line near the center of the edge bar. This may be reduced by placing light-turning features with more symmetric facets near the center of the edge bar, as discussed above. Another design which may also reduce the center dark line is a cross-cut design. In the embodiments illustrated in FIGS. 11A-11C and 12A-12C, the first set 1111 and the second set 1112 do not overlap, and represent distinct regions of the edge bar 901 about the center 1110. However, allowing the first set 1111 and the second set 1112 to overlap may reduce the dark line near the center of the edge bar 901.

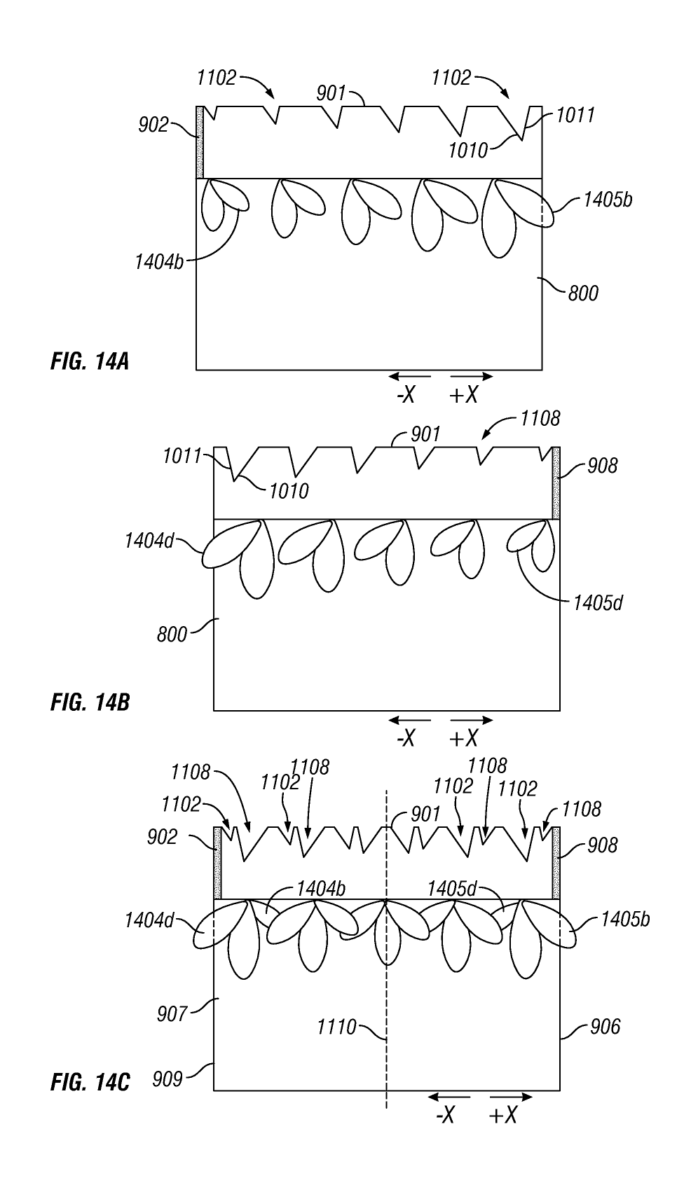

FIG. 14A illustrates an embodiment of an edge bar 901 with light-turning features 1102 having asymmetric facets 1010, 1011 along the entirety of the length of the edge bar 901. The light-turning features 1102 have asymmetric facets 1010, 1011 such that more light propagating along one direction, e.g., the +x direction, is extracted than light propagating in the opposite direction, e.g., the −x direction. As illustrated, the light-turning features 1102 have an increasing cut depth further away from LED 902. In the embodiment illustrated here, light-turning features 1102 are shown even near LED 902. However, these features 1102 have small cut depths, and therefore extract less light than the greater-cut-depth features 1102 further away from LED 902. More precisely, the features 1102 further away from LED 902 extract a greater portion of the light propagating in the desired direction (e.g., away from LED 902) at a given location along the length of the edge bar 901 than the features 1102 that are closer to LED 902. Hence, in various embodiments, while features 1102 that are further away are configured to extract a greater portion of light propagating away from LED 902, the actual amount or intensity of light extracted may not necessarily be greater. In other words, in some embodiments, the light turning features of the first set increase in efficiency as a function of distance away from LED 902. The increased extraction of the proportion of propagating light further away from LED 902 is illustrated in FIG. 14A with lobes and side lobes of increasing size. While illustrated with varying cut depth, in some embodiments, the cut depth may be uniform. In some embodiments, features 1102 further away from LED 902 may be configured to extract more than features 1102 that are closer to LED 902 by varying the shape of the turning features, the density of the turning features, varying the cut depth, or any combination of the above. Hence, in some embodiments the cut depth may be uniform, but the number of features 1102 per unit length is larger further away from LED 902 and is smaller for features closer to LED 902. It is understood that the light-turning features 1102, 1108 in FIGS. 14A-14C are not drawn to scale relative to the size of the edge bar 901 for clarity. Features similar to the light-turning features and facets discussed throughout the specification herein may have dimensions for cut depth that range from tens to a few hundreds of microns.

FIG. 14B is similar to FIG. 14A, however, the light-turning features 1108 have asymmetric facets 1010, 1011 that are configured to extract more light propagating in a direction that is opposite to the direction light extracted by features 1102 propagates. As illustrated, the features 1108 are configured to extract light propagating in the −x direction, e.g., light propagating away from LED 908. Similar to FIG. 14A, the light-turning features 1108 have greater cut depth further away from LED 908. The features 1108 of greater cut depth may extract more light, as illustrated in FIG. 14B with lobes and side lobes of increasing size. In other words, in some embodiments, the light turning features of the second set increase in efficiency as a function of distance away from LED 908.

FIG. 14C illustrates an embodiment of an edge bar 901 with a cross cut design. As illustrated, FIG. 14C represents a superimposition or addition of FIGS. 14A and 14B. Hence unlike the embodiments discussed in FIGS. 11A-11C and 12A-12C, in some embodiments some features 1102 that extract light from LED 902 are present along most of or the entire length of the edge bar 901 and some features 1108 that extract light from LED 908 are also present along most of or the entire length of the edge bar 901. In this way, the first set 1111 and the second set 1112 overlap each other over the entire length of the edge bar 901. While features 1102 that extract light from LED 902 are present along the entire length of the light bar, in the embodiment illustrated in FIG. 14C, they extract a lesser portion of light closer to LED 902 and a greater portion of light further away from LED 902. Similarly, features 1108 extract a lesser portion of light closer to LED 908 and a greater portion of light further away from LED 908. Near the center 1110, light may be extracted from both LEDs 902, 908, and the main lobe near the center has side lobes on both sides. In this way, the dark line near the center 1110 of edge bar 901 and/or the light guide 800 to which edge bar 901 may be optically coupled is reduced or eliminated. It is noted that while “bad” side lobes 1404b, 1405d now appear, they are much smaller than “good” side lobes 1404d and 1405b. In the embodiment of a cross cut design illustrated in FIG. 14C, there may be somewhat of a tradeoff between mitigating the edge shadow artifact and reducing the dark line near the center 1110 of the edge bar 901 and/or light guide 800 to which edge bar 901 is optically coupled.

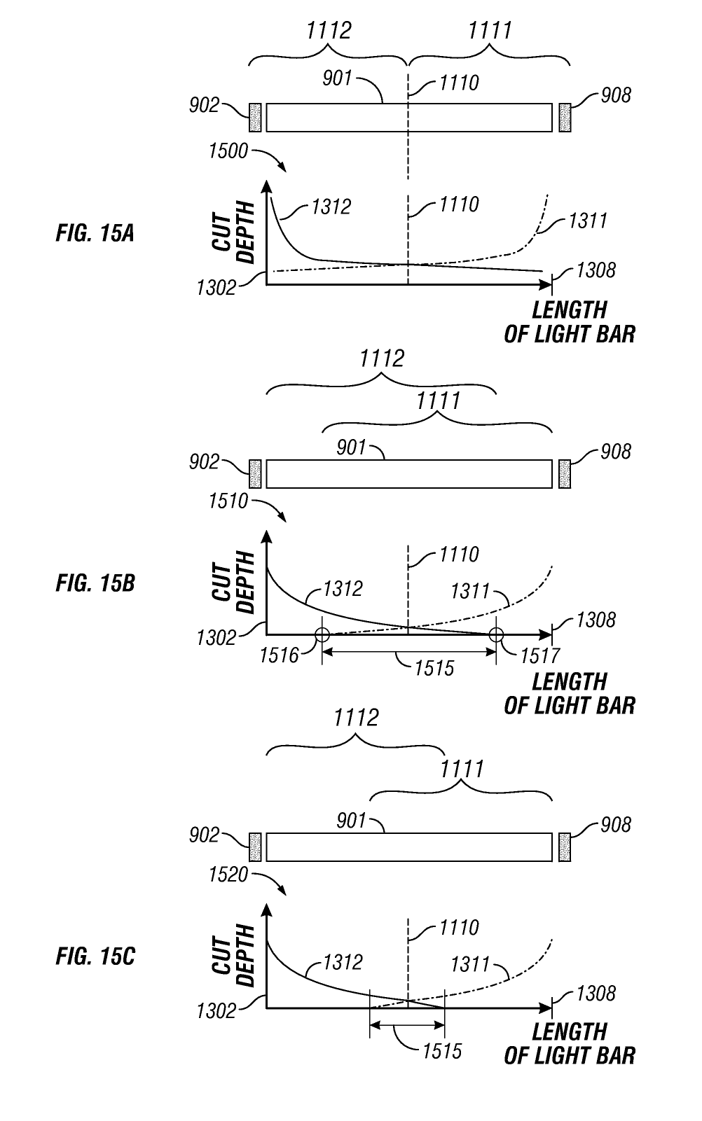

FIG. 15A illustrates a graph 1500 showing the cut depth as a function of the position along the edge bar 901 for an embodiment similar to that of FIG. 14C. As illustrated in graph 1500, light-turning features from both the first 1111 and the second 1112 set are present along most of or the entire length of the edge bar 901.

In the embodiment illustrated in FIG. 14C, the features 1102 and 1108 are present along the entire length of the edge bar 901. As explained above, however, the presence of features close to the LED from which the features extract light may give rise to an unwanted “bad” side lobe. To reduce bad side lobes, it is possible in some embodiments of the cross cut design for the first set 1111 of features 1102 to only partially overlap with the second set 1112 of features 1108.

FIG. 15B illustrates a graph 1510 showing the cut depth as a function of the position along the length of the edge bar 901. However, unlike graph 1500 and the embodiment of FIG. 14C, the first set 1111 of features 1102 and the second set 1112 of features 1108 only partially overlap along cross-cut length 1515. As illustrated, there is a point 1516 where the cut depth of light-turning features 1102 of the first set 1111 diminishes to zero. Similarly, there is a point 1517 where the cut depth of light-turning features 1108 of the second set 1112 diminishes to zero. The length along edge bar 901 between point 1516 and point 1517 is the cross-cut length 1515. In some embodiments the cross-cut length 1515 is less than half the length of the edge bar 901. In various embodiments, the cross-cut length 1515 may vary from close to zero (little or no cross-cut) to the entire edge bar 901 length.

FIG. 15C illustrates a graph 1520 similar to graph 1510, however, in FIG. 15C the cross-cut length is very short. In particular, the cross-cut length 1515 is a narrow overlap of the first set 1111 and the second set 1112 near the center 1110 of the edge bar 901. As noted above, while the embodiments of FIGS. 14C and 15A-15C illustrate variations of the cut depth of the features along the length of the edge bar 901, other variations are possible to vary the amount of extraction of light at a particular position along the edge bar 901 that is propagating in one or an opposite direction. For example, the density of the features may be increased or decreased to increase or decrease the extraction of light at various positions along the edge bar 901 relative to other positions. Alternatively, the shape of the features may be changed. Other changes are possible.

Some of the various embodiments discussed above include two LEDs 902, 908. However, in some embodiments, only one LED 902 may be used at one end, with a reflector or a sawtooth structure at the opposite end, i.e., the end opposite LED 902.

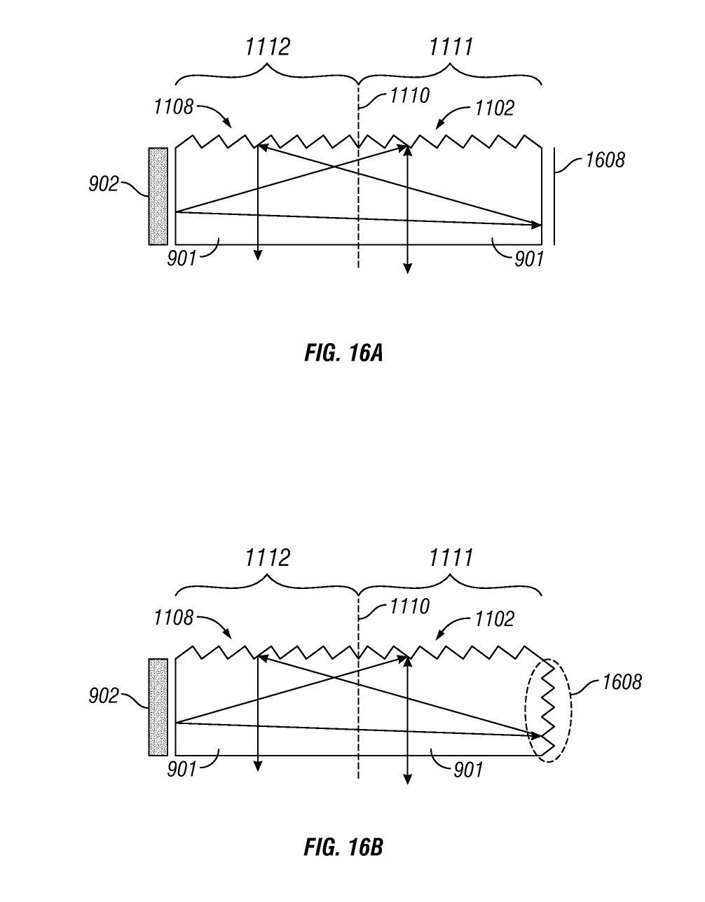

FIGS. 16A and 16B illustrate embodiments of edge bar 901 similar to those above, but with only one LED 902. In such embodiments, the second set 1112 of light-turning features 1108 extract light out of the light guide that propagates in a direction towards LED 902. However, this light does not come from a second LED, unlike the embodiments illustrated in FIGS. 11A-11C, 12C, and 14C where there are two LEDs. Rather, this light was originally injected into the edge bar 901 by LED 902, but the light propagates towards LED 902 by reflecting off of a reflector (shown as 1608 in FIG. 16A) or a reflective features in the light bar 901 such as a sawtooth structure (shown as 1608 in FIG. 16B). Hence, in some of the various embodiments disclosed herein, reflector 1608 or sawtooth structure 1608 may replicate the effect of a light “source.” Similar to the embodiments of FIGS. 11A-11C, 12C, and 14C, the first set 1111 of light-turning features 1102 extract light from LED 902 that is propagating in a direction, e.g., a +x direction, away from LED 902. However, unlike the embodiments of FIGS. 11A-11C, 12C, and 14C, the second set 1112 of light-turning features 1108 also extract light from LED 902, only that such light is propagating in an opposite direction, e.g., a −x direction, due to reflection off of reflector or sawtooth structure 1608 as shown in FIGS. 16A and 16B. Since the intensity of the light reflected from reflector 1608 may be less than the intensity of the light from LED 902, the two sets of light-turning features may differ from each other in terms of the length of the portion of the edge bar comprising the sets, the depth of the light-turning features, light-turning feature density, and etc.

While the foregoing detailed description discloses several embodiments of the invention, it should be understood that this disclosure is illustrative only and is not limiting of the invention. It should be appreciated that the specific configurations and operations disclosed can differ from those described above, and that the methods described herein can be used in contexts other than fabrication of illumination devices. The skilled artisan will appreciate that certain features described with respect to one embodiment may also be applicable to other embodiments. For example, embodiments of edge bar 901 with a cross cut design were shown having variable cut depth features, but a cross cut design may include different asymmetric light-turning features that are not cut to variable depths, but are rather cut to a uniform depth. Similarly, an embodiment of an edge bar 901 having variable cut depth light-turning features need not be a cross cut design such that the first set and the second set of light-turning features do not overlap. Furthermore, anything discussed above relating to embodiments having two LEDs may also apply to embodiments with only one LED as discussed in regards to FIGS. 16A and 16B. Also, features discussed in relation to LED 902 may also apply to LED 908, and vice versa. Other variations are also possible.

1. An illumination device comprising:
an edge bar configured to have light propagating in a first direction along a length of the edge bar and light propagating in an opposite direction along the length of the edge bar, the edge bar comprising:
a first and a second opposing ends,
a light-exit side,
an opposing side opposite the light-exit side, and
a top side and a bottom side adjacent the light-exit surface;
a first light source optically coupled to the first opposing end such that light from the first light source enters the edge bar and propagates in the first direction; and
a first light-turning feature formed on one of the opposing side, the light-exit side, the top side, and the bottom side, wherein the first light-turning feature extracts more light that propagates in the first direction than the feature extracts from light that propagates in the opposite direction.

2. The illumination device of claim 1, wherein the edge bar is coupled to a light guide and wherein the edge bar and the light guide are configured to reduce an edge shadow in the light guide compared to an edge bar having light-extracting turning features that extract light substantially equally in the first and opposite directions.

3. The illumination device of claim 1, further comprising a second light source optically coupled to the second opposing end such that light from the second light source enters the edge bar and propagates in the opposite direction.

4. The illumination device of claim 1, further comprising one of a reflector, a sawtooth structure, and a light-emitting diode.

5. The illumination device of claim 3, wherein the edge bar further comprises a second light-turning feature, wherein the second light-turning feature extracts more light propagating in the opposite direction than in the first direction.

6. The illumination device of claim 5, wherein the first and second light-turning feature comprises asymmetric facets.

7. The illumination device of claim 5, wherein the edge bar comprises a first set of the first light-turning features and a second set of the second light-turning features.

8. The illumination device of claim 7, wherein some of the facets of the first set of the first light-turning features are mirror symmetric to some of the facets of the second set of the second light-turning features.

9. The illumination device of claim 7, wherein the edge bar has a first region and a second region such that a greater number of the first set of the first light-turning features is formed in the first region of the edge bar than is formed in the second region and a greater number of the second set of the second light-turning features is formed in the second region of the edge bar than is formed in the second region.

10. The illumination device of claim 9, wherein the first light-turning features of the first set extract more light from the first light source than the second light source and the second light-turning features of the second set extract more light from the second light source than the first light source.

11. The illumination device of claim 10, wherein the edge bar is coupled to a light guide and wherein the edge bar and the light guide are configured to reduce an edge shadow in the light guide compared to an edge bar having light-extracting turning features that extract light substantially equally in the first and opposite directions.

12. The illumination device of claim 11, further comprising a display integrated with the light guide and illuminated by the light guide.

13. The illumination device of claim 12, wherein the display comprises an array of interferometric modulators.

14. The illumination device of claim 10, wherein the light-turning features of the first set have a cut depth that varies (e.g. increases) with distance from the first light source.

15. The illumination device of claim 10, wherein the light-turning features of the first set vary (e.g. increase) in efficiency as a function of distance from the first light source.

16. The illumination device of claim 9, wherein the first region and the second region of the edge bar are separated by a center of the edge bar.

17. The illumination device of claim 16, further comprising facets that equally extract light propagating in both the first and the opposite directions disposed at or near the center of the edge bar.

18. The illumination device of claim 7, wherein the first set of the first light-turning features and the second set of the second light-turning features overlap along a cross-cut length of the edge bar.

19. The illumination device of claim 18, wherein the cross-cut length equals length of the edge bar.

20. The illumination device of claim 18, wherein the cross-cut length equals one half of length of the edge bar.

21. The illumination device of claim 1, further comprising:
a light guide coupled to the edge bar;
a display which can be illuminated by the light guide;
a processor that is configured to communicate with said display, said processor being configured to process image data; and
a memory device that is configured to communicate with said processor.

22. The illumination device as recited in claim 21, further comprising a driver circuit configured to send at least one signal to said display.

23. The illumination device as recited in claim 22, further comprising a controller configured to send at least a portion of said image data to said driver circuit.

24. The illumination device as recited in claim 21, further comprising an image source module configured to send said image data to said processor.

25. The illumination device as recited in claim 24, wherein said image source module comprises at least one of a receiver, transceiver, and transmitter.

26. The illumination device as recited in claim 25, further comprising:
an input device configured to receive input data and to communicate said input data to said processor.

27. A method of manufacturing an illumination device comprising:
providing an edge bar configured to have light propagating in a first direction along a length of the edge bar and light propagating in an opposite direction along the length of the edge bar, the edge bar comprising:
a first and a second opposing ends,
a light-exit side,
an opposing side opposite the light-exit side, and
a top side and a bottom side adjacent the light-exit surface; and
disposing a first light-turning feature on one of the opposing side, the light-exit side, the top side, and the bottom side, wherein the first light-turning feature extracts more light that propagates in the first direction than the feature extracts from light that propagates in the opposite direction.

28. The method of claim 27, further comprising forming a second light-turning feature, wherein the second light-turning feature extracts more light propagating in the opposite direction than in the first direction.

29. The method of claim 28, wherein forming one of the first and second light-turning feature comprises one of embossing, casting, and injection molding.

30. The method of claim 28, further comprising coupling the edge bar to a first light source.

31. The method of claim 28, further comprising coupling the edge bar to a second light source.

32. The method of claim 28, wherein forming the first and second light-turning features comprises forming asymmetric facets.

33. The method of claim 28, wherein forming the first and second light-turning features comprises forming a first set of the first light-turning features and a second set of the second light-turning features.

34. The method of claim 33, wherein the edge bar has a first region and a second region such that a greater number of the first set of the first light-turning features is formed in the first region of the edge bar than is formed in the second region and a greater number of the second set of the second light-turning features is formed in the second region of the edge bar than is formed in the second region.

35. The method of claim 34, further comprising:
coupling the edge bar to a first light source to the first opposing end; and
coupling the edge bar to a second light source to the second opposing end, wherein the first light-turning features of the first set extract more light from the first light source than the second light source and the second light-turning features of the second set extract more light from the second light source than the first light source.

36. The method of claim 35, further comprising coupling the edge bar to a light guide, wherein the edge bar and the light guide are configured to reduce an edge shadow in the light guide compared to an edge bar having light-extracting turning features that extract light substantially equally in the first and opposite directions.

37. The method of claim 35, further comprising integrating the light guide with a display to provide illumination to the display.

38. The method of claim 37, wherein the display comprises an array of interferometric modulators.

39. An illumination device comprising:
a light-guide means for guiding light in a first direction along a length of the light-guide means and for guiding light in an opposite direction along the length of the light-guide means, the light-guide means comprising:
a first and a second opposing ends,
a light-exit side,
an opposing side opposite the light-exit side, and
a top side and a bottom side adjacent the light-exit surface;
a first illuminating means for providing to the first opposing end such that light from the first illuminating means enters the light-guide means and propagates in the first direction;
a first light-turning means for turning light out of the light-guide means formed on one of the opposing side, the light-exit side, the top side, and the bottom side, wherein the first light-turning means extracts more light that propagates in the first direction than the feature extracts from light that propagates in the opposite direction; and
a second light-turning means for turning light out of the light-guide means formed on one of the opposing side, the light-exit side, the top side, and the bottom side, wherein the second light-turning means extracts more light that propagates in the opposite direction than in the first direction.
